(19) United States
(12) Patent Application Publication
(10) Pub. No.: US 2018/0154906 A1
(43) Pub. Date: Jun. 7, 2018

(54) AUTONOMOUS VEHICLE PROCESSOR SELF-DIAGNOSTIC

(71) Applicant: Ford Global Technologies, LLC, Dearborn, MI (US)

(72) Inventors: Aed M. Dudar, Canton, MI (US); Mahmoud Yousef Ghannam, Canton, MI (US)

(73) Assignee: Ford Global Technologies, LLC, Dearborn, MI (US)

(21) Appl. No.: 15/368,751

(22) Filed: Dec. 5, 2016

(51) Int. Cl. B60W 50/029; B60W 50/02; B60W 30/08; B60R 21/0136; G05D 1/00; G07C 5/08

(52) U.S. Cl. CPC B60W 50/029; B60W 50/0205; B60W 30/08; B60R 21/0136; G05D 1/0088; B60R 2021/01013; G07C 5/0808; B60W 2050/0292; B60W 2050/021; B60W 2030/082; G05D 1/0055

(57) ABSTRACT

A vehicle system includes a processor programmed to perform a self-diagnostic test, of the processor, in response to receiving an impact signal. The impact signal represents an impact involving a host vehicle. The processor is further programmed to request remote processing of at least one autonomous vehicle operation in response to the processor failing the self-diagnostic test.

### BACKGROUND

The Society of Automotive Engineers (SAE) has defined multiple levels of autonomous vehicle operation. At levels 0-2, a human driver monitors or controls the majority of the driving tasks, often with no help from the vehicle. For example, at level 0 (“no automation”), a human driver is responsible for all vehicle operations. At level 1 (“driver assistance”), the vehicle sometimes assists with steering, acceleration, or braking, but the driver is still responsible for the vast majority of the vehicle control. At level 2 (“partial automation”), the vehicle can control steering, acceleration, and braking under certain circumstances without human interaction. At levels 3-5, the vehicle assumes more driving-related tasks. At level 3 (“conditional automation”), the vehicle can handle steering, acceleration, and braking under certain circumstances, as well as monitoring of the driving environment. Level 3 requires the driver to intervene occasionally, however. At level 4 (“high automation”), the vehicle can handle the same tasks as at level 3 but without relying on the driver to intervene in certain driving modes. At level 5 (“full automation”), the vehicle can handle almost all tasks without any driver intervention.

### BRIEF DESCRIPTION OF THE DRAWINGS

FIG. 1 illustrates an example host vehicle with a control system, which performs a self-diagnostic test following an impact involving the host vehicle, in communication with a remote server.

FIG. 2 is a block diagram illustrating example components of the control system.

FIG. 3 is a flowchart of an example process that may be executed by the control system.

### DETAILED DESCRIPTION

Higher levels of automation (SAE Levels 3-5, for example) allow for autonomous vehicle operation with little to no human interaction. If an autonomous vehicle operating at a high level of autonomous operation is involved in an accident, a human may not be present to assess the amount of damage to the vehicle, call a tow truck, call emergency services, move the vehicle out of the roadway, etc. Thus, after the accident, the autonomous vehicle may remain in the roadway even if it is otherwise able to drive away. Alternatively, the autonomous vehicle may attempt to drive away from an accident despite major vehicle subsystems being damaged as a result of the accident.

One way to address such instances is with an autonomous vehicle with a processor that performs a self-diagnostic test and requests remote help depending on the outcome of the self-diagnostic test. Specifically, one solution includes a vehicle system with a processor programmed to perform a self-diagnostic test, of the processor, in response to receiving an impact signal. The impact signal represents an impact involving the host vehicle. The processor is further programmed to request remote processing of at least one autonomous vehicle operation in response to the processor failing the self-diagnostic test. This vehicle system may permit the host vehicle to operate in a limp-home mode even under circumstances where the processor itself is damaged during the accident.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

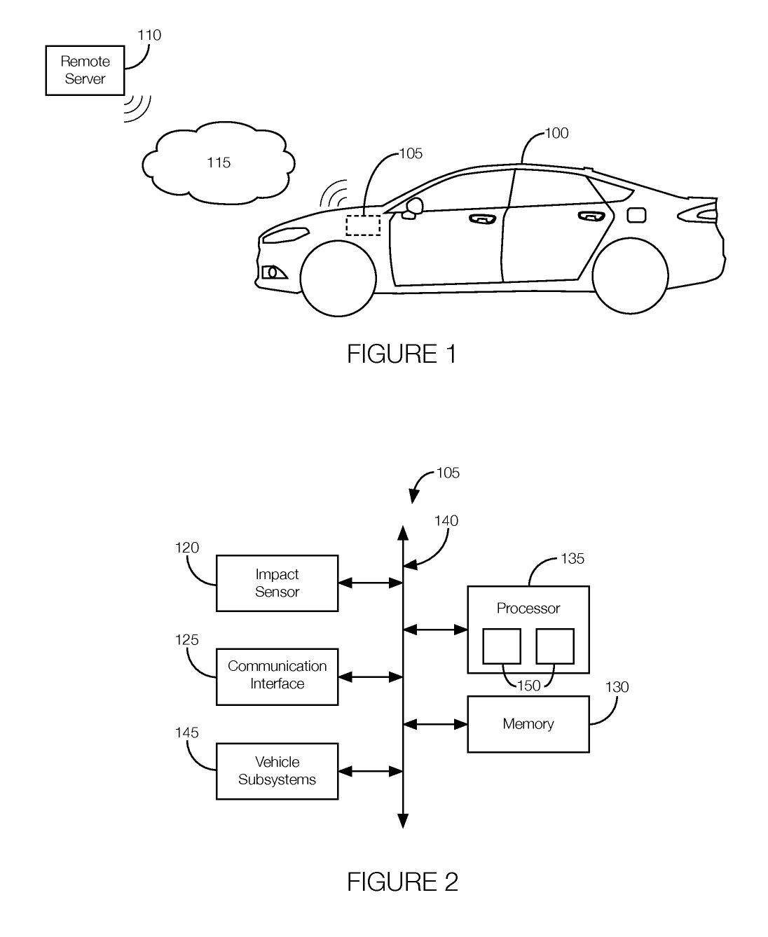

As illustrated in FIG. 1, a host vehicle 100 includes a control system 105 in communication with a remote server 110 via a communication network 115. The control system 105 performs a self-diagnostic test following an impact involving the host vehicle 100. If the control system 105 fails the self-diagnostic test, which could mean that the control system 105 is unable to properly control certain autonomous vehicle operations, the control system 105 requests remote processing of one or more autonomous vehicle operations. In such instances, the remote server 110 may remotely process signals transmitted from the control system 105 and transmit control signals back to the control system 105 so that the autonomous vehicle operations can be controlled, at least to operate the host vehicle 100 in a limp-home mode.

The limp-home mode may refer to a mode where a set of autonomous vehicle operations can be executed to autonomously control the host vehicle 100 to move the host vehicle 100 out of the roadway, to a service center, or both, after an accident. The limp-home mode may further define certain autonomous vehicle operations that are not available, even if the subsystems associated with those operations are working properly. Further, the limp-home mode may impose limits on certain autonomous vehicle operations. For instance, when operating in the limp-home mode, the host vehicle 100 may not be permitted to operate above a maximum speed, such as 8 mph.

The remote server 110 is implemented via circuits, chips, or other electronic components that can receive and process signals transmitted from the control system 105 to the remote server 110 via the communication network 115. The remote server 110 may be implemented, therefore, via a cloud-based computing device. The remote server 110 may be programmed to receive and transmit signals via any number of communication protocols such as packet-switched network protocols, satellite communication protocols, cellular communication protocols, or the like.

The communication network 115 is implemented via hardware components such as network nodes (gateways, terminals, cell towers, satellites, satellite dishes, etc.), circuits, chips, or other electronic components that can facilitate communication of data between the host vehicle 100 and the remote server 110. The communication network 115 may transmit communications via any number of communication protocols such as a packet-switched network protocols, satellite communication protocols, cellular communication protocols, or the like.

The control system 105 may be incorporated into various electronic systems of the host vehicle 100. Further, a single host vehicle 100 may have multiple control systems 105. For example, the control system 105 may be incorporated into an engine control unit, a transmission control unit, a powertrain control module, a restraint control module, a body control module, etc.

Although illustrated as a sedan, the host vehicle 100 may include any passenger or commercial automobile such as a car, a truck, a sport utility vehicle, a crossover vehicle, a van, a minivan, a taxi, a bus, etc. The host vehicle 100 may be an autonomous vehicle that can operate in an autonomous (e.g., driverless) mode, a partially autonomous mode, or a non-autonomous mode.

Referring now to FIG. 2, the control system 105 includes or works in accordance with at least one impact sensor 120, a communication interface 125, memory 130, and a processor 135 in communication over a vehicle network 140. The vehicle network 140 is implemented via circuits, chips, network hardware, or other electronic components that can facilitate wired or wireless network communication via, e.g., a controller area network (CAN) bus, Ethernet, Bluetooth®, Bluetooth® Low Energy, etc.

The impact sensors 120 are implemented via circuits, chips, or other electronic components, such as an accelerometer or proximity sensor, that can detect an impact involving the host vehicle 100. The impact may result from an impact with another vehicle (motorized or human-powered), a pedestrian, or an object such as a tree, road sign, fire hydrant, guard rail, embankment, etc., or anything else sufficient to cause damage to the host vehicle 100 or one or more subsystems 145 of the host vehicle 100. In response to detecting the impact, the impact sensor 120 may output an impact signal, which may indicate that the host vehicle 100 has been involved in an impact. The impact signal may further indicate the severity of the impact. For instance, a “high” impact signal may indicate a severe crash while a “low” impact signal may indicate a less severe crash (e.g., a “fender-bender”). The impact signal may be output to the processor 135 over the vehicle network 140.

The communication interface 125 is implemented via an antenna, circuits, chips, or other electronic components that can facilitate wired or wireless communication external to the host vehicle 100. For instance, the communication interface 125 may be programmed to transmit signals over the communication network 115 in accordance with any number of wired or wireless communication protocols including packet-switched network protocols, cellular communication protocols, satellite communication protocols, vehicle-to-vehicle or vehicle-to-infrastructure communication protocols such as the Dedicated Short Range Communication protocol (DSRC), or the like. The communication interface 125 may be further programmed to receive signals transmitted to the host vehicle 100 via the communication network 115 in accordance with such protocols. The communication interface 125 may be programmed to output signals to, e.g., the processor 135 or other components of the host vehicle 100, and receive signals from the processor 135 or other components of the host vehicle 100, via the vehicle network 140.

The memory 130 is implemented via circuits, chips, or other electronic components that can electronically store data, including instructions executable by the processor 135 to control one or more of the autonomous vehicle operations. The memory 130 may refer to read only memory (ROM), random-access memory (RAM), or the like. Although shown as a separate component, the memory 130 may be incorporated into the processor 135. Thus, references to the processor 135 performing a self-diagnostic test may refer to the processor 135 performing a diagnostic of the memory 130.

The processor 135 is implemented via circuits, chips, or other electronic components that can process the impact signals output by the impact sensors 120 and determine to what extent the host vehicle 100 can operate in a limp-home mode. In some instances, the processor 135 is a multi-core processor 135 (e.g., implemented via multiple cores 150). Prior to carrying out the limp-home mode, the processor 135 is programmed to perform a self-diagnostic test to determine whether it is working properly. If not, the processor 135 is programmed to request remote processing of certain autonomous vehicle operations, such as those associated with the limp-home mode (discussed in greater detail below), request a flash of the memory 130, or the like.

The processor 135 may be programmed to perform the self-diagnostic test, which is defined as a set of instructions executed by the processor 135 to determine whether the processor 135 (specifically each core 150 of the processor 135), the memory 130, or both, are working properly. The processor 135 may be programmed to perform the self-diagnostic test in response to receiving the impact signal. Performing the self-diagnostic test may include determining whether the memory 130 has been corrupted, whether any of the cores 150 of the processor 135 have failed, etc. Determining whether the memory 130 has been corrupted may include writing a string of bits to the memory 130 and reading back that string of bits to determine whether the memory 130 was able to accurately store the correct string of bits. Determining whether one or more of the cores 150 have failed may include having each core 150 perform various operations or computations. If one or more of the cores 150 is unable to perform the operation or computation, the self-diagnostic test may indicate that core 150 that was unable to perform the operation or computation has failed.

Under some circumstances, such as if the processor 135 fails the self-diagnostic test because one or more of the cores 150 or the memory 130 has failed, the processor 135 may be programmed to request a core flash from the remote server 110. The core flash may refer to a process where the data stored in or accessible to the core 150 is deleted and new data, such as new instructions executable by the core 150, are uploaded to the core 150 or the memory 130 accessible to the core 150. Thus, a “core flash” may refer to uploading instructions to the core 150, to the memory 130, or both. The remote server 110 may transmit the new data to the control system 105 via the communication network 115. The communication interface 125 may receive the new instructions and upload them to the core 150 at the command of the processor 135.

While waiting for the core flash to be completed, the processor 135 may request that the remote server 110 remotely handle processing of one or more autonomous vehicle operations that would otherwise be handled by the core 150, at least until the core flash is complete. When the core flash is complete, the processor 135 may be programmed to perform a subsequent self-diagnostic test to, e.g., determine whether the core flash was completed successfully. The subsequent self-diagnostic test may include the processor 135 instructing the core 150 to perform certain operations or calculations. The processor 135 may determine whether the core flash was successful based at least in part on whether the core 150 can perform the operations or calculations during the subsequent self-diagnostic test.

The processor 135 may be further programmed to determine whether other autonomous vehicle subsystems 145, associated with operating the host vehicle 100 in the limp-home mode, remain operational after receiving the impact signal. For instance, the processor 135 may determine whether one or more of the fuel pump, the fuel rail, the ignition coils, the battery, the starter motor, the fuel injectors, the spark plugs, the heated exhaust gas oxygen (HEGO) sensors, the gear shifter, the navigation sensors, the restraint control module, the actuators for accelerating, braking, and steering the vehicle, etc., are working properly. Assuming that at least a certain subset of those or possibly other autonomous vehicle operations are functional despite the impact, the processor 135 may determine that the host vehicle 100 can operate in the limp-home mode. In some instances, the processor 135 may determine that the host vehicle 100 can operate in the limp-home mode even if certain subsystems 145 such as an exhaust gas recirculation (EGR) system, a catalytic converter, the evaporative emissions system (EVAP), etc., are not working properly following the impact. Moreover, certain issues, such as a vacuum leak, may not prevent the host vehicle 100 from operating in the limp-home mode. Such failed subsystems 145 may not prevent the host vehicle 100 from operating the limp-home mode since the host vehicle 100 will only travel at a low speed, a short distance, or both.

The processor 135 may be programmed to take additional precautions prior to allowing the host vehicle 100 to operate in the limp home mode even though certain subsystems 145 appear to be working properly. For instance, the processor 135 may be programmed to require the engine to run for a few minutes before permitting a shift out of “park” to confirm that the engine can operate without significant issues. After confirming that the engine can operate, the processor 135 may be programmed to allow the host vehicle 100 to shift out of “park” by, e.g., outputting a control signal to an autonomous mode controller, a transmission control unit, etc. The processor 135 may be further programmed to observe the vehicle speed and direction, and compare the vehicle speed and direction to data received from an on-board navigation system. The processor 135 may use such information to determine whether the host vehicle 100 is properly operating in the limp-home mode. If not, the processor 135 may be programmed to abandon the limp-home mode, local processing of the autonomous vehicle operations, or both. Other precautions include the processor 135 outputting control signals to turn on the hazard lights, communicate that the host vehicle 100 is operating in the limp-home mode via vehicle-to-vehicle communication, or both. Further, the processor 135 may output a signal to the restraint control module (RCM) instructing the restraint control module to keep the fuel lines open despite the impact.

If the processor 135 determines that the host vehicle 100 is unable to operate in the limp-home mode, the processor 135 may be programmed to contact emergency services, the vehicle owner, or both. For instance, the processor 135 may be programmed to command the communication interface 125 to transmit a message to emergency services, such as a tow truck, police, fire department, ambulance, etc., or to the vehicle owner via the communication network 115. The message may include the location of the host vehicle 100 as well as additional information such as the state of the host vehicle 100 (e.g., the extent of the damage to the host vehicle 100 as a result of the impact).

If the processor 135 determines that the host vehicle 100 can operate in the limp-home mode, but the processor 135 failed the self-diagnostic test because a core 150 associated with one of the vehicle subsystems 145 used while the host vehicle 100 is operating in the limp-home mode has failed, the processor 135 may request remote processing of the autonomous vehicle operations that would normally be handled by the failed core 150. The processor 135 may transmit, via the communication interface 125, a request to the remote server 110. The request may be transmitted to the remote server 110 over the communication network 115. After a handshake is completed, the processor 135 may transmit signals with data associated with operating the host vehicle 100 in the limp-home mode to the remote server 110. The data may be generated by, e.g., autonomous sensors such as a lidar sensor, a radar sensor, a camera, an ultrasound sensor, etc. Other data transmitted to the remote server 110 may include the speed of the host vehicle 100, the position of the steering wheel, the position of the accelerator pedal, the position of the brake pedal, etc.

The remote server 110 processes the data received and may generate and transmit control signals to the control system 105 via the communication network 115. The communication interface 125 may forward the control signals to the processor 135 or the appropriate subsystems 145 via the vehicle network 140. For instance, control signals for the steering wheel may be transmitted to the steering actuator, control signals for the accelerator pedal may be transmitted to the accelerator pedal actuator, control signals for the brake pedal may be transmitted to the brake pedal actuator, or the like. Thus, the subsystems 145 involved in carrying out the limp-home mode may still operate even though the core 150 associated with such operations has failed.

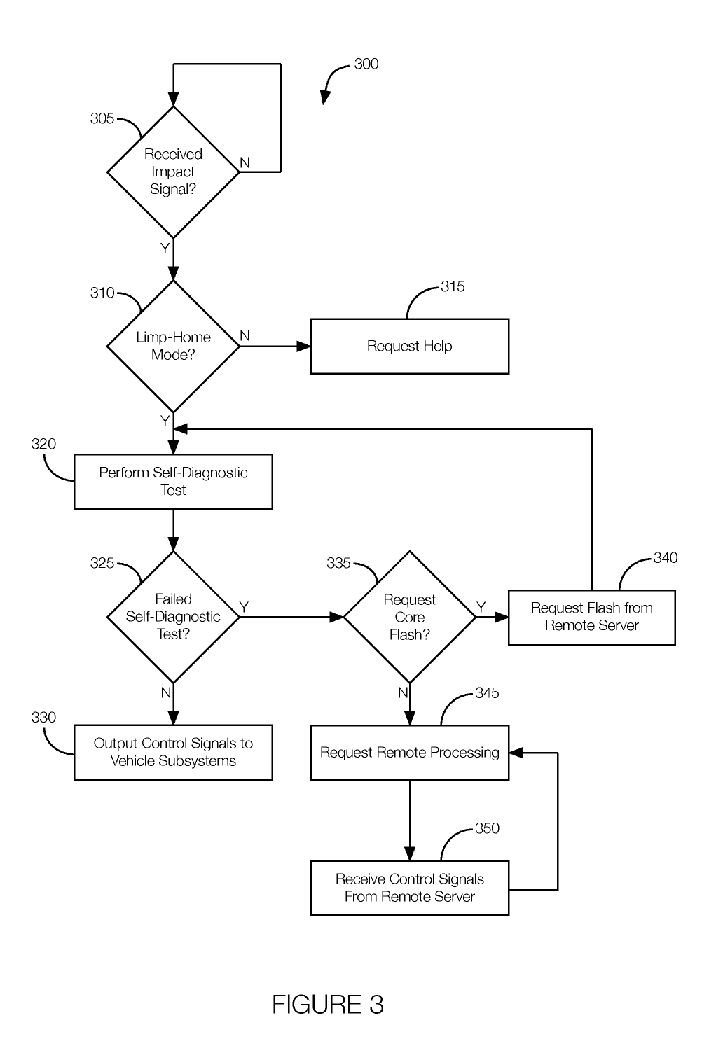

FIG. 3 is a flowchart of an example process 300 that may be executed by the control system 105. The process 300 may be executed any time the host vehicle 100 is operating, and may continue to execute until the host vehicle 100 is, e.g., turned off.

At decision block 305, the control system 105 determines whether an impact signal has been received. The impact signal may indicate that the host vehicle 100 has been involved in an impact. The processor 135 may receive the impact signal output by one or more of the impact sensors 120. If the impact signal is received, the process 300 may proceed to block 310. Otherwise, the process 300 may continue to execute block 305 until the impact signal is received.

At decision block 310, the control system 105 determines whether the host vehicle 100 can operate in the limp-home mode. For instance, the processor 135 may determine whether certain autonomous vehicle subsystems 145 remain operational following the impact. For instance, the processor 135 may determine whether one or more of the fuel pump, the fuel rail, the ignition coils, the battery, the starter motor, the fuel injectors, the spark plugs, the heated exhaust gas oxygen (HEGO) sensors, the gear shifter, the navigation sensors, the restraint control module, the actuators for accelerating, braking, and steering the vehicle, etc., are working properly. If the processor 135 determines that at least a certain subset of those or possibly other autonomous vehicle operations are functional despite the impact, the processor 135 may determine that the host vehicle 100 can operate in the limp-home mode. In such cases, the process 300 may proceed to block 320. If the processor 135 determines that the host vehicle 100 cannot operate in the limp-home mode after the impact, the process 300 may proceed to block 315.

At block 315, the control system 105 requests help. For instance, the processor 135 may command the communication interface 125 to transmit a message to an emergency service provider, the vehicle owner, or both. The emergency service provider may be a tow truck service, the police, the fire department, an ambulance, etc. The message may be transmitted to the emergency services provider via the communication network 115. The message may include the location of the host vehicle 100 as well as additional information such as the state of the host vehicle 100 (e.g., the extent of the damage to the host vehicle 100 as a result of the impact). The process 300 may end after block 315.

At block 320, the control system 105 performs a self-diagnostic test. The self-diagnostic test is a set of instructions executed by the processor 135 to determine whether the processor 135 (specifically each core 150 of the processor 135), the memory 130, or both, are working properly. The processor 135 performs the self-diagnostic test by, e.g., determining whether the memory 130 has been corrupted, whether any of the cores 150 of the processor 135 have failed, etc. Determining whether the memory 130 has been corrupted may include the processor 135 writing a string of bits to the memory 130 and reading back that string of bits to determine whether the memory 130 was able to accurately store the correct string of bits. Determining whether one or more of the cores 150 have failed may include the processor 135 having each core 150 perform various operations or computations. If one or more of the cores 150 is unable to perform the operation or computation, the self-diagnostic test may indicate that core 150 that was unable to perform the operation or computation has failed.

At decision block 325, the control system 105 determines if the processor 135 passed the self-diagnostic test. For instance, the processor 135 may determine if the memory 130 wrote the correct string of bits, if the cores 150 were able to perform the various operations or computations, etc. If so, the processor 135 may determine that the self-diagnostic test was passed, and the process 300 may proceed to block 330. If the processor 135 fails the self-diagnostic test, the process 300 may proceed to block 335.

At block 330, the control system 105 outputs control signals to control various vehicle subsystems 145 in the limp-home mode. That is, the processor 135 outputs control signals to initiate various autonomous vehicle operations associated with operating the host vehicle 100 in the limp-home mode. The control signals may include control signals to operate the steering, acceleration, and braking of the host vehicle 100 in accordance with, e.g., signals received from sensors such as lidar sensor, a radar sensor, a camera, or an ultrasonic sensor. The control signals may also be generated and output in accordance with a navigation system, such as a global positioning system (GPS), that can determine the present location of the host vehicle 100, the destination of the host vehicle 100, and a route from the present location to the destination.

At decision block 335, the control system 105 determines whether to request a core flash. The processor 135 may determine that a core flash should be requested based on the results of the self-diagnostic test. For instance, the processor 135 may request the core flash if, e.g., the memory 130 is able to store data and the failure associated with one or more cores 150 can be corrected by flashing the core 150. The processor 135 may not request the core flash if, e.g., the memory 130 is too corrupted to properly store data or a previous flash was attempted but the core 150 still failed the self-diagnostic test. The process 300 may proceed to block 340 to request the flash from the remote server 110. The process 300 may proceed to block 345 if the processor 135 decides not to request the flash from the remote server 110, which may occur if block 340 has already been executed from a previous iteration of the process 300.

At block 340, the control system 105 requests the core flash from the remote server 110. That is, the processor 135 may command the communication interface 125 to transmit a message to the remote server 110 requesting the core flash. The message requesting the core flash may be transmitted to the remote server 110 over the communication network 115. In response, the remote server 110 may flash the core 150, the memory 130, or both, by transmitting new instructions to the host vehicle 100 via the communication network 115. The communication interface 125 may pass the new instructions to the processor 135, which may upload the new instructions to the core 150, the memory 130, or both. The process 300 may proceed to block 320 so the processor 135 can perform a subsequent self-diagnostic test; that is, so the processor 135 can determine whether the core flash resolved the issues that caused the processor 135 to fail the self-diagnostic test. While waiting for the core flash to be completed, the processor 135 may request that the remote server 110 remotely handle processing of one or more autonomous vehicle operations that would otherwise be handled by the core 150, at least until the core flash is complete.

At block 345, the control system 105 requests remote processing of the host vehicle 100 to operate in the limp-home mode. The processor 135 may command the communication interface 125 to transmit a request for remote processing to the remote server 110 via the communication network 115. The processor 135 may also command the communication interface 125 to transmit signals with data associated with operating the host vehicle 100 in the limp-home mode to the remote server 110. The data may be generated by, e.g., autonomous sensors such as a lidar sensor, a radar sensor, a camera, an ultrasound sensor, etc. Other data transmitted to the remote server 110 may include the speed of the host vehicle 100, the position of the steering wheel, the position of the accelerator pedal, the position of the brake pedal, etc.

At block 350, the control system 105 receives control signals from the remote server 110 and control the host vehicle 100 accordingly. As discussed above, the remote server 110 processes the data transmitted from the host vehicle 100 and, in response, generates and transmits control signals to the control system 105 via the communication network 115. The communication interface 125 may forward the control signals to the processor 135 or the appropriate subsystems 145 via the vehicle network 140. For instance, control signals for the steering wheel may be transmitted to the steering actuator, control signals for the accelerator pedal may be transmitted to the accelerator pedal actuator, control signals for the brake pedal may be transmitted to the brake pedal actuator, or the like. Thus, the subsystems 145 involved in carrying out the limp-home mode may still operate even though the core 150 associated with such operations has failed. The process 400 may continue to execute blocks 335 and 340 until the host vehicle 100 arrives at its destination.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a processor programmed to perform a self-diagnostic test, of the processor, in response to receiving an impact signal representing an impact involving a host vehicle and request remote processing of at least one autonomous vehicle operation in response to the processor failing the self-diagnostic test.

2. The vehicle system of claim 1, wherein the processor includes memory and wherein performing the self-diagnostic test includes determining whether the memory is corrupted.

3. The vehicle system of claim 1, wherein the processor includes multiple cores and wherein performing the self-diagnostic test includes determining whether any of the cores have failed.

4. The vehicle system of claim 1, wherein the processor is programmed to request a core flash from a remote server in response to the processor failing the self-diagnostic test.

5. The vehicle system of claim 4, wherein the remote server assumes remote processing of the at least one autonomous vehicle operation until the core flash is complete.

6. The vehicle system of claim 4, wherein the processor is programmed to perform a subsequent self-diagnostic test after the core flash is complete to determine whether the core flash was completed successfully.

7. The vehicle system of claim 1, wherein the processor is programmed to determine whether at least one autonomous vehicle subsystem remains operational after receiving the impact signal.

8. The vehicle system of claim 7, wherein the processor is programmed to determine whether the host vehicle can operate in a limp-home mode based at least in part on whether the at least one autonomous vehicle subsystem remains operational.

9. The vehicle system of claim 8, wherein the processor is programmed to request remote processing of the at least one autonomous vehicle operation in response to the processor failing the self-diagnostic test and determining that the host vehicle can operate in the limp-home mode.

10. A method comprising:
receiving an impact signal representing an impact involving a host vehicle;
performing, via a processor, a self-diagnostic of the processor; and
requesting remote processing of at least one autonomous vehicle operation in response to the processor failing the self-diagnostic test.

11. The method of claim 10, wherein performing the self-diagnostic test includes determining whether a memory accessible to the processor is corrupted.

12. The method of claim 10, wherein performing the self-diagnostic test includes determining whether at least one core of the processor has failed.

13. The method of claim 10, further comprising requesting a core flash from a remote server in response to the processor failing the self-diagnostic test.

14. The method of claim 13, wherein the remote server assumes remote processing of the at least one autonomous vehicle operation until the core flash is complete.

15. The method of claim 13, further comprising performing a subsequent self-diagnostic test after the core flash is complete to determine whether the core flash was completed successfully.

16. The method of claim 10, further comprising determining whether at least one autonomous vehicle subsystem remains operational after receiving the impact signal.

17. The method of claim 16, further comprising determining whether the host vehicle can operate in a limp-home mode based at least in part on whether the at least one autonomous vehicle subsystem remains operational.

18. The method of claim 17, wherein requesting remote processing of the at least one autonomous vehicle operation occurs in response to the processor failing the self-diagnostic test and determining that the host vehicle can operate in the limp-home mode.

19. A vehicle system comprising:
a sensor programmed to detect an impact involving a host vehicle and output an impact signal representing the impact;
a communication interface programmed to wirelessly communicate with a remote server; and
a processor programmed to perform a self-diagnostic test, of the processor, in response to receiving an impact signal representing an impact involving a host vehicle and request, via the communication interface, remote processing of at least one autonomous vehicle operation by the remote server in response to the processor failing the self-diagnostic test.
